(19) United States
(12) Patent Application Publication
(10) Pub. No.: US 2013/0336562 A1
(43) Pub. Date: Dec. 19, 2013

(54) ADAPTIVELY DETERMINED PARAMETER VALUES IN ITERATIVE RECONSTRUCTION METHOD AND SYSTEM

(71) Applicants: Alexander ZAMYATIN, HAWTHORN WOODS, IL (US); Daxin SHI, Vernon Hills, IL (US); Mihail Petru DINU, Mundelein, IL (US)

(72) Inventors: Alexander ZAMYATIN, HAWTHORN WOODS, IL (US); Daxin SHI, Vernon Hills, IL (US); Mihail Petru DINU, Mundelein, IL (US)

(73) Assignees: TOSHIBA MEDICAL SYSTEMS CORPORATION, OTAWARA-SHI (JP); KABUSHIKI KAISHA TOSHIBA, TOKYO (JP)

(21) Appl. No.: 13/524,832

(22) Filed: Jun. 15, 2012

(51) Int. Cl. G06T 5/00

(52) U.S. Cl. 382/131

(57) ABSTRACT

The CT imaging system optimizes its image generation by adaptively changing parameters in an iterative reconstruction algorithm based upon certain information such as statistical information. The coefficients for the parameters include at least a first coefficient for a predetermined data fidelity process and a second coefficient for a predetermined regularization process in an iterative reconstruction algorithm. The iterative reconstruction algorithm includes the ordered subsets simultaneous algebraic reconstruction technique (OSSART) and the simultaneous algebraic reconstruction technique (SART). The first coefficient and the second coefficient are independently determined using some predetermined statistical information such as noise and or error in matching the real data.

### FIELD OF THE INVENTION

The current invention is generally related to an image processing and system, and more particularly related to optimize image generation by adaptively determining parameter values in an iterative reconstruction algorithm based upon certain information such as statistical information.

### BACKGROUND OF THE INVENTION

For volume image reconstruction, an iterative algorithm has been developed by various groups. One exemplary algorithm is a total variation (TV) minimization iterative reconstruction algorithm for application to sparse views and limited angle x-ray CT reconstruction. Another exemplary algorithm is a TV minimization algorithm aimed at region-of-interest (ROI) reconstruction with truncated projection data in many views, i.e., interior reconstruction problem. Yet another exemplary algorithm is a prior image constrained compressed sensing (PICCS) method. In general, total-variation-based iterative reconstruction (IRTV) algorithms have advantages for sparse view reconstruction problems.

In the prior art attempts, the data processing procedure of well-known IRTV algorithms is illustrated in FIG. 1. For example, simultaneous algebraic reconstruction technique (SART) generates the computed projection data from the image volume and back-projects the normalized difference between the measured projection and the computed projection data to reconstruct an updated image volume. In general, the sharpness is resulted due to a reduced number of errors in matching the real data while noise is increased in the updated image. As a result, the update image may appear sharp but noisy at the same time. Then, the updated image volume is regularized by total variation (TV) minimization routine in order to reduce noise at the cost of resolution.

One prior art processing procedure as illustrated in FIG. 1 is of a sequential scheme. That is, the TV module follows the SART or alternatively projection on convex sets (POCS) module. The original image x⁽ⁿ⁻¹⁾ is processed by the SART routine to reduce an error amount in matching the real data and outputs an intermediate image or image update x_{SART}⁽ⁿ⁾, which now has an increased amount of noise. As the intermediate image or image update x_{SART}⁽ⁿ⁾ is obtained at an improved level of resolution, the original image x⁽ⁿ⁻¹⁾ is updated based upon the image update x_{SART}⁽ⁿ⁾. Then, the intermediate image x_{SART}⁽ⁿ⁾ is weighted by a first coefficient β first before the product is processed by the TV routine to reduce noise and generate an intermediate image x⁽ⁿ⁾, which now has an increased amount of the error. After the intermediate image update x⁽ⁿ⁾ is weighted by a second coefficient α, the original image x⁽ⁿ⁻¹⁾ is updated based upon the output image α·x⁽ⁿ⁾. Due to the above described sequential nature of the processing, the effect of the SART routine initially reduces the error while the TV routine improves the noise in a disjointed manner with regaining the error. Consequently, the first and second coefficients are not effectively determined, and the determination of the two coefficients remains desirable to control the noise-resolution trade-off

A second prior art processing procedure as illustrated in FIG. 2 has the similar sequential scheme of performing SART first and then TV except for the generation of the output image x⁽ⁿ⁾. Despite the difference, the procedure in FIG. 2 generally yields the same undesirable characteristics as described with respect to the procedure in FIG. 1. The original image x⁽ⁿ⁻¹⁾ is processed by the SART routine to reduce an error amount in matching the real data and outputs a first intermediate image or image update x_{SART}⁽ⁿ⁾ which now has an increased amount of noise. As the first intermediate image x_{SART}⁽ⁿ⁾ is obtained at an improved level of resolution, the original image x⁽ⁿ⁻¹⁾ is updated based upon the first intermediate image x_{SART}⁽ⁿ⁾. Then, the first intermediate image x_{SART}⁽ⁿ⁾ is weighted by a first coefficient β first before a first product β·x_{SART}⁽ⁿ⁾ is processed by the TV routine to reduce noise and generate a second intermediate image x_{REG}⁽ⁿ⁾, which now has an increased amount of the error and is weighted by a second coefficient α to generate the second product α·x_{REG}⁽ⁿ⁾. The second product α·x_{REG}⁽ⁿ⁾ is further weighted by a third coefficient λ to generate a further weighted image λ(α·x_{REG}⁽ⁿ⁾) while the first intermediate image x_{SART}⁽ⁿ⁾ is weighted by a complement of the third coefficient (1−λ) to generate (1−λ)x_{SART}⁽ⁿ⁾. After the further weighted images λ(α·x_{REG}⁽ⁿ⁾) and λ(α·x_{REG}⁽ⁿ⁾) are summed together to obtain an output image x⁽ⁿ⁾, the original image x⁽ⁿ⁻¹⁾ is updated based upon the output image x⁽ⁿ⁾.

Determination of the above described parameter values or coefficients such as a and β in FIGS. 1 and 2 is crucial for improving image quality in iterative reconstruction (IR) algorithms. There is no consensus in prior art as to how to automatically determine these parameters for IR algorithms so as to optimize image quality in the reconstructed image. In this regard, the parameters in total variation based iterative reconstruction (IRTV) algorithms are empirically determined, and the parameter values are manually varied in a time consuming manner.

In some detail, the parameters generally include a regularization strength parameter and a relaxation parameter in the iterative reconstruction scheme. These two parameters control certain characteristics in the reconstructed image. For example, if the regularization strength parameter value is increased, the noise is reduced in the IR image while error is increased in matching the real data. On the other hand, if the relaxation parameter is increased, error is reduced in matching to the real data while noise is increased in the IR image. For example, as the error is reduced in matching to the real data, edges in the reconstructed image appear sharp, and the reconstructed image has a better resolution at the cost of blurriness in the background due to the increased noise. For these reasons, the regularization strength parameter and the relaxation parameter need to be balanced for optimal image quality.

In practice, a pair of the fixed values for the regularization strength parameter and the relaxation parameter does not appear to accommodate all clinical demands in the IR reconstructed images. That is, a particular pair of the fixed parameter values may improve image quality in one particular clinical application. On the other hand, the same fixed parameter values generally may not improve image quality in another clinical application.

To improve image quality in the IR reconstructed image for different applications based upon data acquired under various conditions, the manual adjustment of these parameters requires a large amount of time and or may be often an impossible task for users. In view of the above discussed prior art problems, a practical solution is still desired for implementing an iterative reconstruction algorithm that includes an automatic and adaptive determination of the parameter values or coefficients.

### BRIEF DESCRIPTION OF THE DRAWINGS

FIG. 1 is a diagram illustrating steps involved in one prior art process of the Total Variation Iterative Reconstruction (TV-IR).

FIG. 2 is a diagram illustrating steps involved in another prior art process of the Total Variation Iterative Reconstruction (TV-IR).

FIG. 3 is a diagram illustrating one embodiment of the multi-slice X-ray CT apparatus or scanner according to the current invention.

FIG. 4 is a diagram illustrating one embodiment of the reconstruction device according to the current invention.

FIG. 5 is a flow chart illustrating steps involved in a process of optimizing image quality by updating an image using a pair of optimally determined parameter values or coefficients in an iterative reconstruction algorithm according to the current invention.

FIG. 6 is a flow chart illustrating further steps for optimally determining parameter values or coefficients in an iterative reconstruction algorithm according to the current invention.

FIG. 7 is a flow chart illustrating steps involved in a process of independently determining the data fidelity update in an iterative reconstruction algorithm according to the current invention.

FIG. 8 is a flow chart illustrating steps involved in a process of independently determining the regularization update in an iterative reconstruction algorithm according to the current invention.

FIG. 9 is a flow chart illustrating steps involved in a process of optimizing the parameter values based upon the updates in an iterative reconstruction algorithm according to the current invention.

FIG. 10 is a graph illustrating the error amount after the regularization and the relaxation in one exemplary process according to the current invention.

FIG. 11 is a graph illustrating an optimal relationship between the data fidelity update and a regularization update over a course of iterations in an exemplary process according to the current invention.

FIG. 12 is a graph illustrating that the update image depends upon a third additional weight parameter λ, in controlling error and noise according to the current invention.

FIG. 13A is an exemplary image illustrating a reconstructed image of the swine abdomen using a prior art filtered back projection technique.

FIG. 13B is another exemplary image illustrating a reconstructed image of the swine abdomen using a technique with the optimized coefficients according to the current invention.

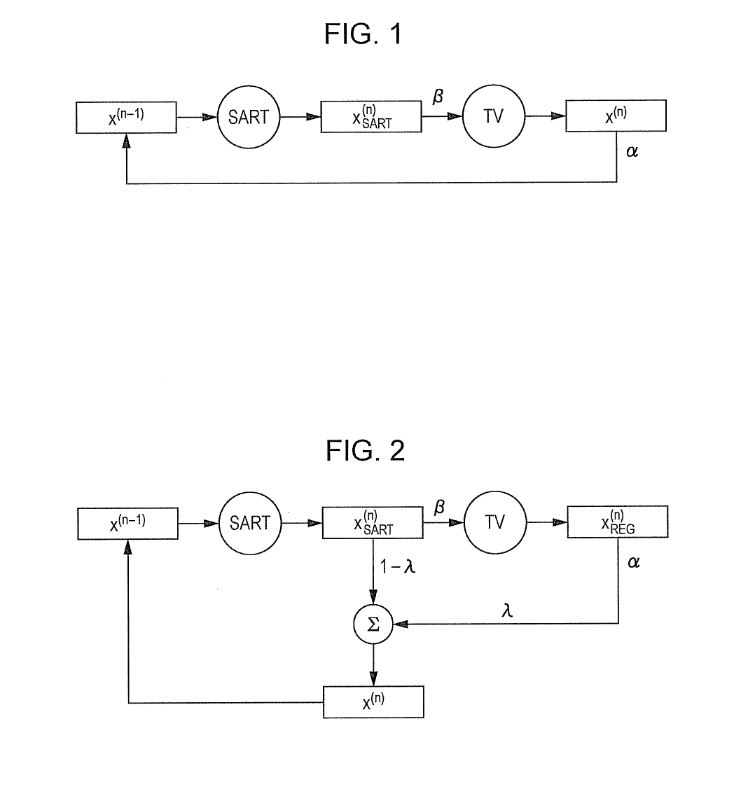

### DETAILED DESCRIPTION OF THE EMBODIMENT(S)

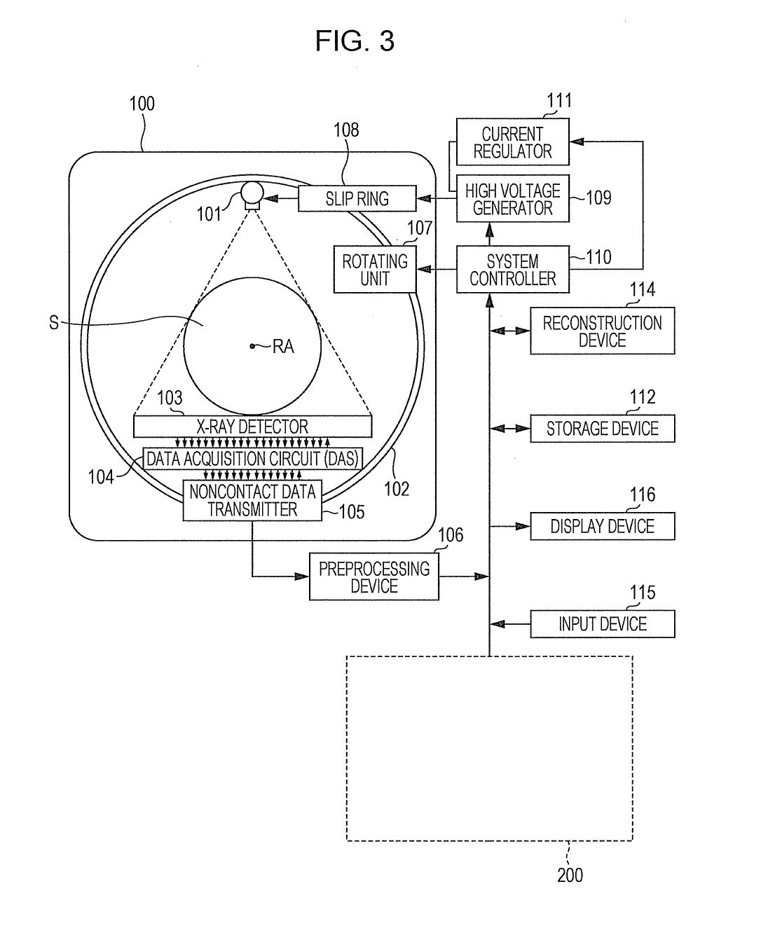

Referring now to the drawings, wherein like reference numerals designate corresponding structures throughout the views, and referring in particular to FIG. 3, a diagram illustrates one X-ray CT apparatus or scanner according to the current invention including a gantry 100 and other devices or units. The gantry 100 is illustrated from a side view and further includes an X-ray tube 101, an annular frame 102 and a multi-row or two-dimensional array type X-ray detector 103. The X-ray tube 101 and X-ray detector 103 are diametrically mounted across a subject S on the annular frame 102, which is rotatably supported around a rotation axis RA. A rotating unit 107 rotates the frame 102 at a high speed such as 0.4 sec/rotation while the subject S is being moved along the axis RA into or out of the illustrated page.

The multi-slice X-ray CT apparatus further includes a high voltage generator 109 and a current regulator 111 that respectively control a tube voltage and a tube current in the X-ray tube 101 through a slip ring 108 so that the X-ray tube 101 generates X ray in response to a system controller 110. The X rays are emitted towards the subject S, whose cross sectional area is represented by a circle. The X-ray detector 103 is located at an opposite side from the X-ray tube 101 across the subject S for detecting the emitted X rays that have transmitted through the subject S. The X-ray detector 103 further includes individual detector elements or units that are conventional integrating detectors.

Still referring to FIG. 3, the X-ray CT apparatus or scanner further includes other devices for processing the detected signals from X-ray detector 103. A data acquisition circuit or a Data Acquisition System (DAS) 104 converts a signal output from the X-ray detector 103 for each channel into a voltage signal, amplifies it, and further converts it into a digital signal. The X-ray detector 103 and the DAS 104 are configured to handle a predetermined total number of projections per rotation (TPPR) that can be at the most 900 TPPR, between 900 TPPR and 1800 TPPR and between 900 TPPR and 3600 TPPR.

The above described data is sent to a preprocessing device 106, which is housed in a console outside the gantry 100 through a non-contact data transmitter 105. The preprocessing device 106 performs certain corrections such as sensitivity correction on the raw data. A storage device 112 then stores the resultant data that is also called projection data at a stage immediately before reconstruction processing. The storage device 112 is connected to the system controller 110 through a data/control bus, together with a reconstruction device 114, an input device 115, a display device 116 and the scan plan support apparatus 200. The scan plan support apparatus 200 includes a function for supporting an imaging technician to develop a scan plan.

One embodiment of the reconstruction device 114 further includes various software and hardware components. According to one aspect of the current invention, the reconstruction device 114 of the CT apparatus advantageously determine parameter values or coefficients that are used in improving image quality in a predetermined iterative reconstruction (IR) algorithm. In general, the reconstruction device 114 in one embodiment of the current invention operates the total variation iterative reconstruction (TVIR) algorithm, which performs on the projection data an ordered subset simultaneous algebraic reconstruction technique (OS-SART) step and a TV minimization step.

During the ordered subsets simultaneous algebraic reconstruction technique (OS-SART), the reconstruction device 114 also performs two major operations. Namely, the reconstruction device 114 re-projects the image volume to form the computed projection data and back-projects the normalized difference between the measured projection' and the computed projection data to reconstruct an updated image volume. In further detail, one embodiment of the reconstruction device 114 re-projects the image volume by using the ray tracing technique where no coefficient of the system matrix is cached. Moreover, one embodiment of the reconstruction device 114 simultaneously re-projects all rays in a subset. In the back-projection, one embodiment of the reconstruction device 114 uses a pixel-driven technique to back-project all of the normalized difference projection data in a subset to form the desired updated image volume. This and other embodiments performing other iterative reconstruction algorithms such as simultaneous algebraic reconstruction technique (SART) are optionally included in the current scope of the invention as more particularly claimed in the appended claims.

The OS-SART and TV steps provide somewhat opposing effects on the image quality during the reconstruction. After OS-SART, some sharpness is resulted due to a reduced number of errors in matching the real data while noise is increased in the updated image. As a result, the update image may appear sharp but noisy at the same time. In the total variation (TV) minimization step, one embodiment of the reconstruction device 114 repeats the TV minimization step X times where X is a predetermined number to improve noise at the cost of resolution.

One embodiment of the reconstruction device 114 advantageously determines a tradeoff between a resolution level and a noise level by updating an image using a pair of parameter values or coefficients to weight the result of OS-SART (data fidelity update) and that of TV minimization (regularization update) in a predetermined iterative reconstruction algorithm so as to optimize image quality. That is, for each iteration, at least two parameter values or coefficients are adaptively determined for the data fidelity update and the regularization update in an automatic manner so that the control for minimizing the noise and the error is more efficient than determining one coefficient and then the other coefficient. The adaptively determined coefficients are applied to the data fidelity update and the regularization update before updating the image from a previous iteration in a predetermined IR algorithm.

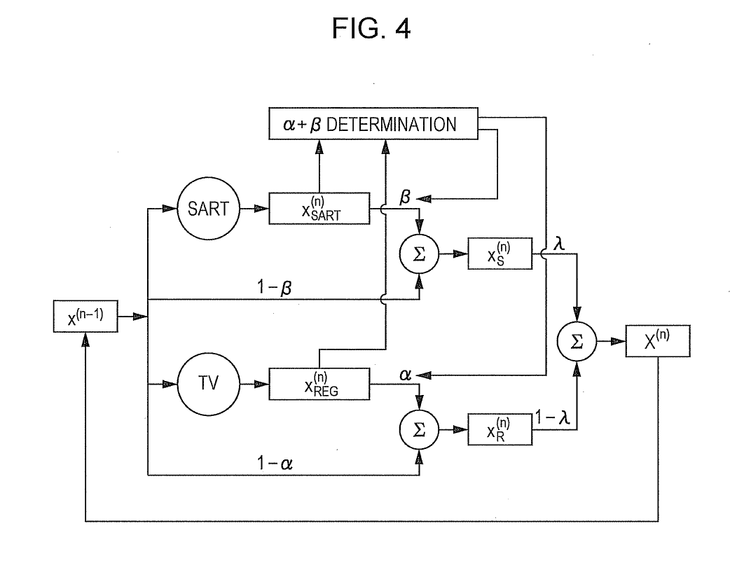

Now referring to FIG. 4, a diagram illustrates illustrating one embodiment of the reconstruction device according to the current invention. The embodiment is implemented either as a software module, a hardware unit or a combination of both in the X-ray CT apparatus or scanner. In the following, the term, “unit” is used to mean any combination of software and hardware implementation. In general, the original image x⁽ⁿ⁻¹⁾ is processed by a SART unit and a TV unit, and the processing at the SART unit and the TV unit is either sequential, in parallel or any combination thereof That is, the SART unit and the TV unit independently perform their tasks to determine their outputs.

The SART unit performs on the original image x⁽ⁿ⁻¹⁾ to reduce an error amount in matching the real data and outputs a first intermediate image or image update x_{SART}⁽ⁿ⁾, which now has an increased amount of noise. The SART unit also outputs the image update x_{SART}⁽ⁿ⁾ to an α+β determination unit to determine a relaxation parameter value or a first coefficient β based upon the changes in the current iteration. The first intermediate image or image update x_{SART}⁽ⁿ⁾ is weighted by the relaxation parameter value or the first coefficient β. By the same token, the original image x⁽ⁿ⁻¹⁾ is weighted by a complementary relaxation parameter value or a first complementary coefficient (1−β). The two weighted images are summed together to a first normalized SART updated image x_{S}⁽ⁿ⁾. During this independent process, the original image x⁽ⁿ⁻¹⁾ is not updated.

In an independent manner, the TV unit performs on the original image x⁽ⁿ⁻¹⁾ to reduce a noise level and outputs a second intermediate image or image update x_{REG}⁽ⁿ⁾, which now has an increased amount of error in matching the real data. The TV unit also outputs the image update x_{REG}⁽ⁿ⁾ to the α+β determination unit to determine a regularization parameter value or a second coefficient α based upon the changes in the current iteration. The second intermediate image or image update x_{REG}⁽ⁿ⁾ is weighted by the regularization strength parameter value or the second coefficient α. By the same token, the original image x⁽ⁿ⁻¹⁾ is weighted by a complementary regularization strength parameter value or a second complementary coefficient (1−α). The two weighted images are summed together to a second noanalized TV updated image x_{R}⁽ⁿ⁾. During this independent process, the original image x⁽ⁿ⁻¹⁾ is not updated.

The a α+β determination unit generally determines optimal parameter values or coefficients in an efficient manner. The optimal values are determined in a certain predetermined manner for the relaxation parameter value or the first coefficient β and the regularization strength parameter value or the second coefficient α. One exemplary manner is based upon statistical information such as variance in noise and error in matching the real data. Any combination of the noise and error variance is optionally used to determine the optical parameter values.

After the first normalized SART updated image x_{S}⁽ⁿ⁾ and the second normalized TV updated image x_{R}⁽ⁿ⁾ are independently obtained, these two images are added together while they are being normalized to output a reconstructed image x⁽ⁿ⁾. The first normalized SART updated image x_{S}⁽ⁿ⁾ is also called the data fidelity update and is further optionally weighted by a noise-resolution parameter value or a third coefficient λ. In this regard, the second normalized TV updated image x_{R}⁽ⁿ⁾ is also called the regularization update and is further optionally weighted by a complementary noise-resolution parameter value or a third complementary coefficient (1−λ). That is, the independently determined data fidelity and regularization updates are optionally normalized by the third pair of coefficients, and λ and (1−λ), which are generally determined by a user in an empirical manner. One exemplary user interface for determining the λ value is implemented as a turning knob.

Finally, the original image x⁽ⁿ⁻¹⁾ is updated based upon the reconstructed image x⁽ⁿ⁾ in a single step. That is, for each iteration, the data fidelity update and the regularization update are summed together at the same time in a single step to generate the reconstructed image x⁽ⁿ⁾ so that the original image x⁽ⁿ⁻¹⁾ is now updated. Thus, an image is updated once by using both the data fidelity update and the regularization update together at the same time so that the control for minimizing the noise and the error is more efficiently and effectively exerted than by applying these updates in a sequential manner. Consequently, the noise-resolution trade-off is substantially improved in the total-variation-based iterative reconstruction technique (TV-IR) such as TV-OS-SART.

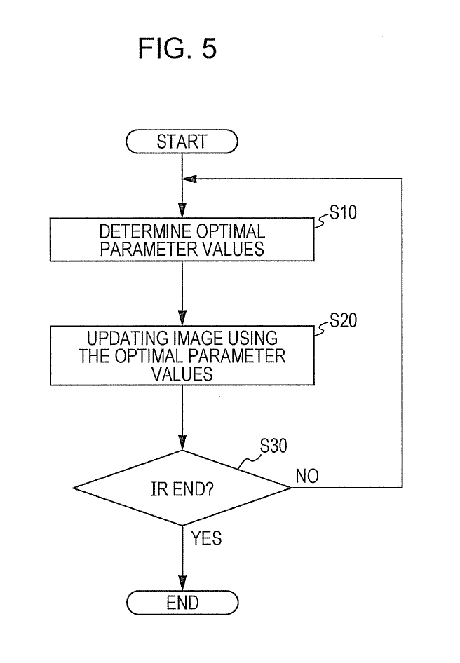

Now referring to FIG. 5, a flow chart illustrates steps involved in a process of optimizing image quality by updating an image using a pair of optimally determined parameter values or coefficients in an iterative reconstruction algorithm according to the current invention. In a first step S10, at least two parameter values such as the relaxation parameter value or the first coefficient β and the regularization strength parameter value or the second coefficient α are determined in a predetermined manner. In this regard, the tasks of determining the two coefficients may be implemented in a sequential process and or a parallel process. As described with respect to FIG. 4, the two coefficients such as the relaxation parameter value and the regularization strength parameter value are respectively determined by a predetermined process that is optionally independent or concurrent.

Still referring to FIG. 5, after the two optimal coefficients such as the relaxation parameter value and the regularization strength parameter value are determined in a predetermined manner, a data fidelity update and a regularization update of the current iteration are respectively weighted according to the two optimal coefficients in a step S20. The data fidelity update and the regularization update have been obtained during the current iteration of a predetermined iterative reconstruction (IR) technique such as an ordered subset simultaneous algebraic reconstruction technique (OS-SART). Subsequently, an image is updated using a pair of the two weighted image updates together at the same time also in the step S20 in a predetermined iterative reconstruction algorithm according to the current invention. As described with respect to FIG. 4, the two weighted updates such as the data fidelity update and the regularization update are concurrently applied as a single image update to the original image for each of the iterations.

Finally, in a step S30, it is determined as to whether or not the iteration needs to end a predetermined iterative reconstruction algorithm such as OS-SART and SART in one exemplary process according to the current invention. In one exemplary process, the termination condition may be based upon a predetermined number of iterations. In another exemplary process, the termination condition may be based upon a predetermined condition in iterations. In any case, if the process is not yet ready to terminate as decided in the step S30, the exemplary process repeats from the step S10. On the other hand, if the step S30 determines that the exemplary process is to be terminated, the exemplary process outputs a reconstructed image and terminates its process.

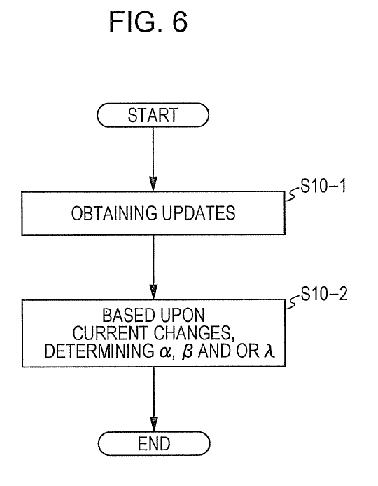

Now referring to FIG. 6, a flow chart illustrates further steps of the step S10 of FIG. 5 for optimally determining parameter values or coefficients in an iterative reconstruction algorithm according to the current invention. Initially, for each for the iterations, a data fidelity update and a regularization update are respectively determined in a step S10-1 before at least two parameter values such as the relaxation parameter value or the first coefficient β and the regularization strength parameter value or the second coefficient α are determined in a predetermined manner in a step S10-2. In this regard, the data fidelity update and the regularization update are obtained to determine the current changes that are used to optimize the relaxation parameter value or the first coefficient β and the regularization strength parameter value or the second coefficient α. In the step S10-2, a user defined parameter value or the third coefficient λ is optionally determined.

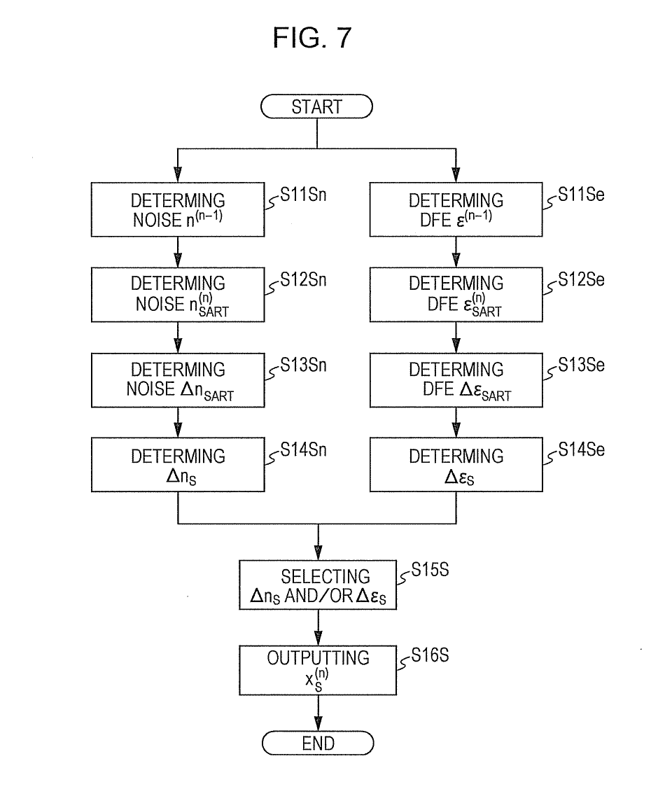

Now referring to FIG. 7, a flow chart illustrates steps involved in a process of independently determining the data fidelity update in an iterative reconstruction algorithm according to the current invention. In general, the data fidelity update is determined based upon certain statistical information such as noise and or error. The noise is a noise level in the original image and its updated image while the error is an amount of error in matching the real data in the original image and its updated image during the iterative process. Since the data fidelity update is determined based upon a combination of noise and error, steps S11Sn through S14Sn determine the data fidelity update based upon the noise information while steps S11Se through S14Se determine the data fidelity update based upon the error information. The data fidelity update reflects any combination of the two sources of the information.

For the noise-based determination, the steps S11Sn through S14Sn ultimately determine a weighted noise change. In a first step S11Sn, given an image x⁽ⁿ⁻¹⁾ at iteration n−1, noise n⁽ⁿ⁻¹⁾ is determined in the image x⁽ⁿ⁻¹⁾. A predetermined reconstructive technique including SART is applied to the image x⁽ⁿ⁻¹⁾ with a fixed relaxation parameter value having a strong value such as 1 so as to obtain x_{SART}⁽ⁿ⁾=SART [x⁽ⁿ⁻¹⁾] and to compute n_{SART}⁽ⁿ⁾ in a step S12Sn from x_{SART}⁽ⁿ⁾. Based upon the above determined noise values n⁽ⁿ⁻¹⁾ and n_{SART}⁽ⁿ⁾ in the steps S11Sn and step S12Sn, the noise change Δn_{SART}=n_{SART}⁽ⁿ⁾−n⁽ⁿ⁻¹⁾ is determined in the step S13Sn. Finally, a weighted noise change Δn_{S}=βΔn_{SART}, where β is the SART strength parameter or the relaxation parameter in S14Sn.

By the same token, for the error-based determination, the steps S11Se through S14Se ultimately determine a weighted error change. In a first step S11Se, given an image x⁽ⁿ⁻¹⁾ at iteration n−1, data fidelity error ε⁽ⁿ⁻¹⁾ is determined in the image x⁽ⁿ⁻¹⁾. A predetermined reconstructive technique including SART is applied to the image x⁽ⁿ⁻¹⁾ with a fixed relaxation parameter value having a strong value such as 1 so as to obtain x_{SART}⁽ⁿ⁾=SART[x⁽ⁿ⁻¹⁾] and to compute ε_{SART}⁽ⁿ⁾ in a step S12Se from x_{SART}⁽ⁿ⁾. Based upon the above determined data fidelity error values ε⁽ⁿ⁻¹⁾ and ε_{SART}⁽ⁿ⁾ in the steps S11Se and step S12Se, the data fidelity error change Δε_{SART}=ε_{SART}⁽ⁿ⁾−ε⁽ⁿ⁻¹⁾ is determined in the step S13Se. Finally, a weighted data fidelity error change Δε_{S}=βΔε_{SART}, where β is the SART strength parameter or the relaxation parameter in S14Se.

In details, the SART update or data fidelity update x_{S}⁽ⁿ⁾ is defined by x_{S}⁽ⁿ⁾=x⁽ⁿ⁻¹⁾+β(x_{SART}⁽ⁿ⁾−x⁽ⁿ⁻¹⁾), where (x_{SART}⁽ⁿ⁾−x⁽ⁿ⁻¹⁾)is obtained in terms of Δn_{SART} alone, Δε_{SART} alone or a combination of Δn_{SART} and Δε_{SART} as illustrated in a step S15S of FIG. 7. Upon selecting a combination of noise and error, a step S16S outputs the SART update or data fidelity update x_{S}⁽ⁿ⁾. The above described steps are merely exemplary in determining the SART update or data fidelity update x_{S}⁽ⁿ⁾, and a proper scope of the current invention is not limited to the above exemplary steps.

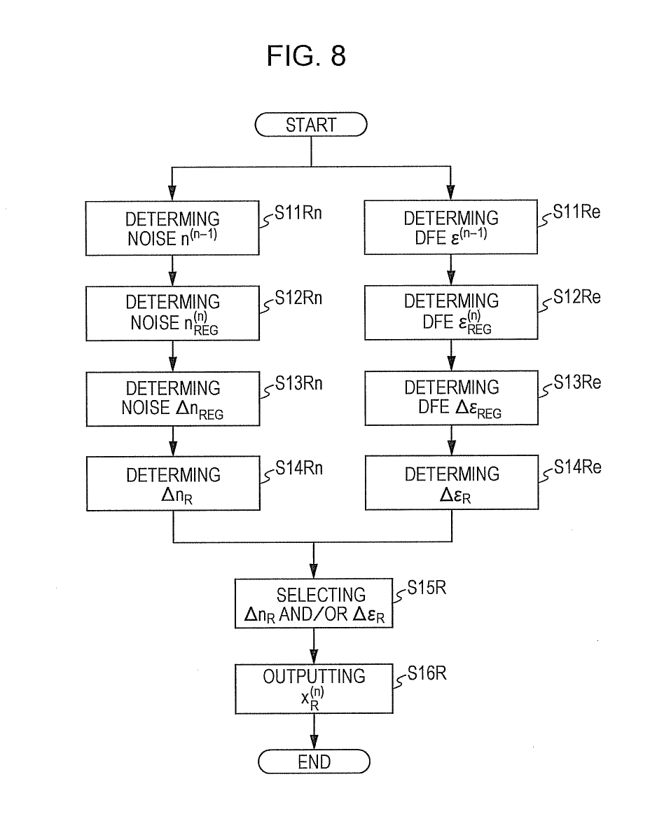

Now referring to FIG. 8, a flow chart illustrates steps involved in a process of independently determining the regularization update in an iterative reconstruction algorithm according to the current invention. In general, the regularization update is determined based upon certain statistical information such as noise and or error. The noise is a noise level in the original image and its updated image while the error is an amount of error in matching the real data in the original image and its updated image during the iterative process. Since the regularization update is determined based upon a combination of noise and error, steps S11Rn through S14Rn determine the regularization update based upon the noise information while steps S11Re through S14Re determine the regularization update based upon the error information. The regularization update reflects any combination of the two sources of the information.

For the noise-based determination, the steps S11Rn through S14Rn ultimately determine a weighted noise change. In a first step S11Rn, given an image x⁽ⁿ⁻¹⁾ at iteration n−1, noise n⁽ⁿ⁻¹⁾ is determined in the image x⁽ⁿ⁻¹⁾. A predetermined regularization technique including total variation (TV) minimization is applied to the image x⁽ⁿ⁻¹⁾ with a fixed regularization parameter value having a strong value such as 1 so as to obtain x_{REG}⁽ⁿ⁾=REG [x⁽ⁿ⁻¹⁾] and to compute n_{REG}⁽ⁿ⁾ in a step S12Rn from x_{REG}⁽ⁿ⁾. Based upon the above determined noise values n⁽ⁿ⁻¹⁾ and n_{REG}⁽ⁿ⁾ in the steps S11Rn and step S12Rn, the noise change Δn_{REG}=n_{REG}⁽ⁿ⁾−n⁽ⁿ⁻¹⁾ is determined in the step S13Rn. Finally, a weighted noise change Δn_{R}=αΔn_{REG}, where α is the TV strength parameter or the regularization strength parameter in S14Rn.

By the same token, for the error-based determination, the steps S11Re through S14Re ultimately determine a weighted error change. In a first step S11Re, given an image x⁽ⁿ⁻¹⁾ at iteration n−1, data fidelity error ε⁽ⁿ⁻¹⁾ is determined in the image x⁽ⁿ⁻¹⁾. A predetermined regularization technique including TV minimization is applied to the image x⁽ⁿ⁻¹⁾ with a fixed regularization parameter value having a strong value such as 1 so as to obtain x_{REG}ⁿ=REG[x⁽ⁿ⁻¹⁾ and to compute ε_{REG}⁽ⁿ⁾ in a step S12Re from x_{REG}⁽ⁿ⁾. Based upon the above determined regularization error values ε^{(m-1)} and ε_{REG}⁽ⁿ⁾ in the steps S11Re and step S12Re, the regularization error change Δε_{REG}=ε⁽ⁿ⁻¹⁾ is determined in the step S13Re. Finally, a weighted regularization error change Δε_{R}=αΔε_{REG}, where α is the TV strength parameter or the regularization strength parameter in S14Re.

In details, the TV update or regularization update x_{R}⁽ⁿ⁾ is defined by x_{R}⁽ⁿ⁾=x⁽ⁿ⁻¹⁾+α(x_{REG}⁽ⁿ⁾−x⁽ⁿ⁻¹⁾), where (x_{REG}⁽ⁿ⁾−x⁽ⁿ⁻¹⁾) is obtained in terms of Δn_{REG} alone, Δε_{REG} alone or a combination of Δn_{REG} and Δε_{REG} as illustrated in a step S15R of FIG. 8. Upon selecting a combination of noise and error, a step S16R outputs the TV update or regularization update x_{R}⁽ⁿ⁾. The above described steps are merely exemplary in determining the TV update or regularization update x_{R}⁽ⁿ⁾, and a proper scope of the current invention is not limited to the above exemplary steps.

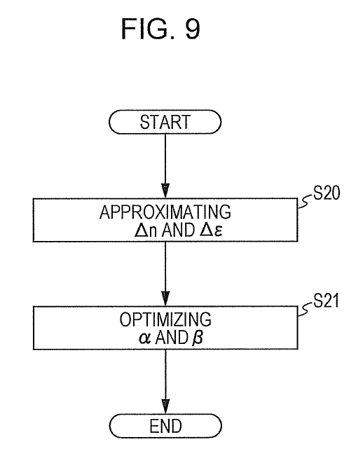

Now referring to FIG. 9, a flow chart illustrates steps involved in a process of optimizing the parameter values based upon the updates in an iterative reconstruction algorithm according to the current invention. In the following, it is assumed that the data fidelity update x_{S}⁽ⁿ⁾ and the regularization update x_{R}⁽ⁿ⁾ are respectively determined based upon a combination of both noise and error as described above with respect to FIGS. 7 and 8. Furthermore, it is also assumed that a third additional weight parameter λ has been determined and applied in controlling error and noise according to the current invention. Thus, the final image x⁽ⁿ⁾ is expressed by λx_{S}⁽ⁿ⁾+(1−λ)x_{R}⁽ⁿ⁾ in relation to the two image updates x^{S}⁽ⁿ⁾, x_{R}⁽ⁿ⁾ and the third additional weight parameter λ.

In a step S20, the noise and error in the final image x⁽ⁿ⁾ are approximated based upon the above assumptions. Δn=λΔn_{S}+(1−λ)Δn_{R}: The noise An in the final image x⁽ⁿ⁾ is a sum of the weighted noise change after SART.λΔn_{S}, where Δn_{S}=βΔn_{S}=βΔn_{SART} and the weighted noise change after TV (1−λ)Δn_{R}, where Δn_{R}=αΔn_{REG}. Similarly, Δε=λΔε_{S}+(1−λ)Δε_{R}: the error Δε in the final image x⁽ⁿ⁾ is a sum of the weighted error change after SART λΔε_{S}, where Δε_{S}=βΔε_{SART} and the weighted error change after TV(1−λ)Δε_{R}, where Δε_{R}=αΔε_{REG}.

Now referring to a step S21 in FIG. 9, at least two parameter values such as the first coefficient β and the second coefficient a are optimized in a predetermined manner in one exemplary technique according to the current invention. One exemplary technique determines a penalty function ƒ(Δn, Δε), and the function ƒ(Δn, Δε) is minimized to optimize the first coefficient β and the second coefficient α in each of the iterations in a predetermined iterative reconstruction technique. That is, (α, β)=arg min ƒ(Δn, Δε). For example a quadratic cost function is used as follows:

ƒ(α, β)=(n⁽ⁿ⁻¹⁾+Δn)²+w(ε⁽ⁿ⁻¹⁾+Δε)²

where a parameter w is a “scaling” parameter so that Δn and Δε ascertained to be of the same magnitude. The parameter w is used to equalize the weight of both factors, and it can be decided only once based on how errors and noise are computed. It can also be used to control the weight of each factor

To find the minimum, the equations,

$$\frac{\partial f}{\partial α} = 0$$

$$and$$

$$\frac{\partial f}{\partial β} = 0$$

are solved using the following notations for simplicity.

n=n⁽ⁿ⁻¹⁾>0

e=ε⁽ⁿ⁻¹⁾>0

s=Δn_{SART}>0

t=Δn_{REG}<0

u=Δε_{SART}21 0

v=Δε_{REG}>0

Based upon the above notations, g and h are now defined as follows:

g=n+Δn=n+λβs+(1−λ)αt

h=e+Δε=e+λβu+(1−λ)αv.

Then, the following derivatives are determined as follows:

$$\frac{\partial g}{\partial α} = ( 1 - λ ) t , \\ \frac{\partial g}{\partial β} = λ s$$

$$\frac{\partial h}{\partial α} = ( 1 - λ ) v , \\ \frac{\partial h}{\partial β} = λ u$$

By relating the above defined g and h to the function ƒ(α,β),

$$f ( α , β ) = {g}^{2} + {wh}^{2}$$

$$\frac{1}{2} \frac{\partial f}{\partial α} = g \frac{\partial g}{\partial α} + wh \frac{\partial h}{\partial α} = 0$$

$$\frac{1}{2} \frac{\partial f}{\partial β} = g \frac{\partial g}{\partial β} + wh \frac{\partial h}{\partial β} = 0$$

$$α ( 1 - λ ) ( {t}^{2} + {wv}^{2} ) + βλ ( st + wuv ) = - n t - wev$$

$$α ( 1 - λ ) ( st + wuv ) + β λ ( {s}^{2} + {wu}^{2} ) = - n s - weu$$

$$By solving [ \begin{matrix}A & B \\ C & D\end{matrix} ] [ \begin{matrix}α \\ β\end{matrix} ] = [ \begin{matrix}G \\ H\end{matrix} ] , \\ [ \begin{matrix}α \\ β\end{matrix} ] = \frac{1}{AD - BC} [ \begin{matrix}D & - B \\ - C & A\end{matrix} ] [ \begin{matrix}G \\ H\end{matrix} ] . \\ A = ( 1 - λ ) ( {t}^{2} + {wv}^{2} ) , \\ B = λ ( st + wuv ) , \\ G = - n t - wev$$

Another way to optimize the coefficients α and β is defined by the following equations. To optimize a regularization parameter a, some statistical information such as variance is used to determine the regularization parameter value.

$$α = \frac{Var \{ {x}^{( n - 1 )} \}}{Var \{ {x}^{( n - 1 )} \} + Var \{ {x}_{REG}^{( n )} \}}$$

where α is the coefficient while an amount of the variance is Var{x⁽ⁿ⁾} at the particular iteration of n, Var{x⁽ⁿ⁻¹⁾} at the particular iteration of n−1 and Var{x_{REG}⁽ⁿ⁾} after the predetermined regularization process. For example, the amount of the variance is defined by noise variance. Alternatively, the amount of the variance is defined by error variance.

To optimize a relaxation parameter β, some statistical information such as variance is used to determine the relaxation parameter value.

$$β = \frac{Var \{ {x}^{( n - 1 )} \}}{Var \{ {x}^{( n - 1 )} \} + Var \{ {x}_{SART}^{( n )} \}}$$

where β is the coefficient while an amount of the variance is Var{x⁽ⁿ⁾} at the particular iteration of n, Var{x⁽ⁿ⁻¹⁾} at the particular iteration of n−1 and Var{x_{REG}⁽ⁿ⁾} after the predetermined relaxation process. For example, the amount of the variance is defined by noise variance. Alternatively, the amount of the variance is defined by error variance.

In the above discussed parameter value optimization, one exemplary error determination is expressed in the following equation. For example, an amount of the data fidelity error ε is determined for a particular image volume xⁿ based upon the same equation.

$$ɛ ( {x}^{n} ) = {( \frac{1}{N} {\sum }_{i = 0}^{i < N} {( {D}_{i} \vert {R}_{i}^{n} ( {x}^{n} ) - {R}_{i}^{0} \vert )}^{p} )}^{\frac{1}{p}}$$

where i is a ray index ranging from 0 to N, which is N_{view} N_{seg} N_{ch}. N_{view} denotes a number of views, N_{seg} denotes a number of segments, and N_{ch} denotes a number of channels. Dᵢ is a statistical weight corresponding to each measurement of the ray i. R° denotes original raw data, and Rⁿ denotes reprojected data from volume xⁿ. ρ is an arbitrarily selected number. For example, if ρ=2, the right side of the above equation resembles root mean square error (RMSE). Although RMSE is suitable if data differences have normal distribution, RMSE provides a large weight on outliers. On the other hand, if ρ=1, the right side of the above equation resembles mean absolute error (MAE), which is more suitable in general for non-Gaussian variables. The arbitrarily selected value of p=1 seems more stable.

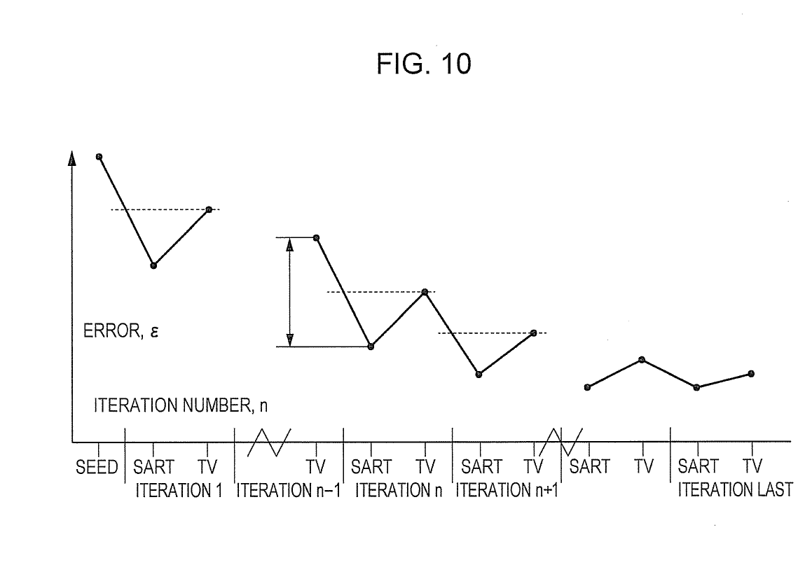

Now referring to FIG. 10, a graph illustrates the error amount after of the regularization and the relaxation in one exemplary process according to the current invention. The graph indicates an error amount on the Y axis after each of the regularization and the relaxation over a number of iterations on the X axis. In the particular embodiment as shown, the error amount gradually decreases over a number of iterations. In general, during each of the iterations, the error amount goes down after SART or the relaxation while the error amount goes up after TV or the regularization. Although the above decrease-increase cycle in error continues over a number of iterations, the overall error amount gradually decreases as the iteration is repeated.

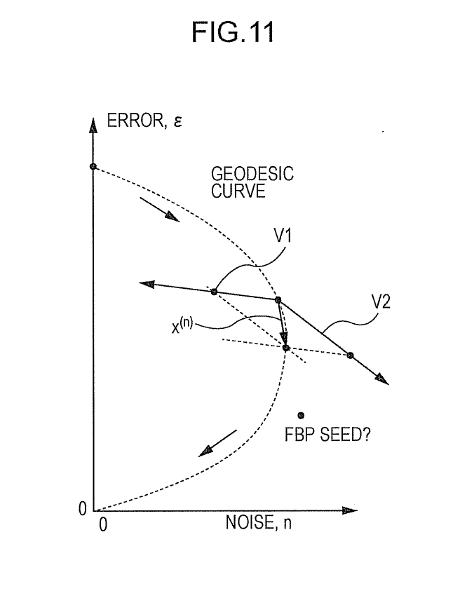

Now referring to FIG. 11, a graph illustrates an optimal relationship between the data fidelity update and a regularization update over a course of iterations in an exemplary process according to the current invention. The X axis indicates a noise amount, n while the Y axis indicates an error amount ε. The graph illustrates that a final image x⁽ⁿ⁾ is expressed by a summation of two vectors including a data fidelity update vector V2 and a regularization update V1 along a predetermined Geodesic curve over iterations. The predetermined Geodesic curve is a function that minimizes the energy of the curve so that the coefficients have the minimal values. In one exemplary process, the data fidelity update is a simultaneous arithmetic reconstructive technique (SART) update while the regularization update is a total variation (TV) update. From one analysis based upon a predetermined Geodesic curve that the exemplary process starts with a zero seed. During the initial iterations, the SART update should be strong while the TV update should be weak. During the middle iterations, the SART update and the TV update should balanced with each other so as to stay on the geodesic curve. Noise increase is optionally acceptable as long as an overall cost function reduces. During the final iterations, both the SART update and the TV update are small. Although the key is to avoid error increase, the exemplary process obviously cannot reach a point (0, 0) by progressing along the Geodesic curve.

In this regard, to analyze iteration convergence, the slopes of the predetermined Geodesic curve are determined. That is, the slope mₛ of V1 and the m_{R} of V2 are respectively defined as follows:

m_{S}=|Δε_{S}/Δn_{S}|

m_{R}=|ε_{R}/Δn_{R}|

To ascertain that a predetermined algorithm converges, the final image stays on the predetermined Geodesic curve. That is, to have the converging effect, the slopes should have a m_{S}>m_{R}. Once m_{S}=m_{R} is reached, additional iterations no longer converge. Note also that once m_{S}=M_{R} is reached, the denominator AD-BC of

$$[ \begin{matrix}α \\ β\end{matrix} ] = \frac{1}{AD - BC} [ \begin{matrix}D & - B \\ - C & A\end{matrix} ] [ \begin{matrix}G \\ H\end{matrix} ] .$$

collapses, and optimal parameter values cannot be found.

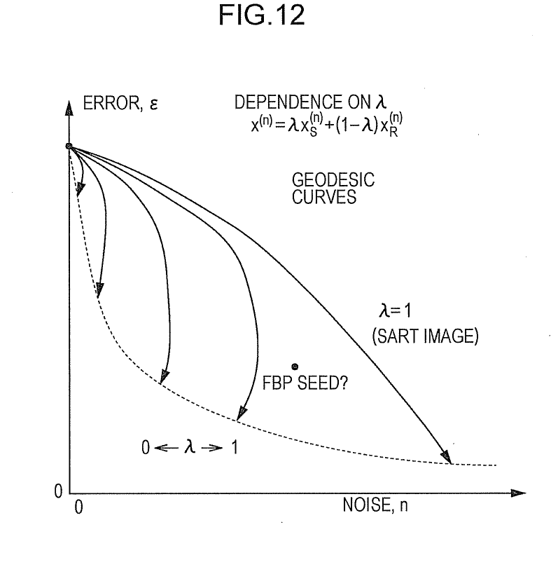

Now referring to FIG. 12, a graph illustrates that the update image depends upon a third additional weight parameter λ in controlling error and noise according to the current invention. In general, error and noise may be optionally controlled by an additional parameter as an image x_{R}⁽ⁿ⁾ is updated based upon the data fidelity update x_{S}⁽ⁿ⁾ and the regularization update x_{R}⁽ⁿ⁾. The final image x⁽ⁿ⁾ is expressed by λx_{S}⁽ⁿ⁾+(1−λ)x_{R}⁽ⁿ⁾ in relation to the two updates, and error and noise in the final image depend upon a value of the third additional weight parameter λ. In other words, the noise-resolution is optionally controlled by the third additional weight parameter λ. As the λ value increases to 1, the error decreases while the noise increases. In other words, the image x⁽ⁿ⁾ becomes more like a SART image with a sharp appearance but a noisy background. On the other hand, as the λ, value decreases, the error increases while the noise decreases.

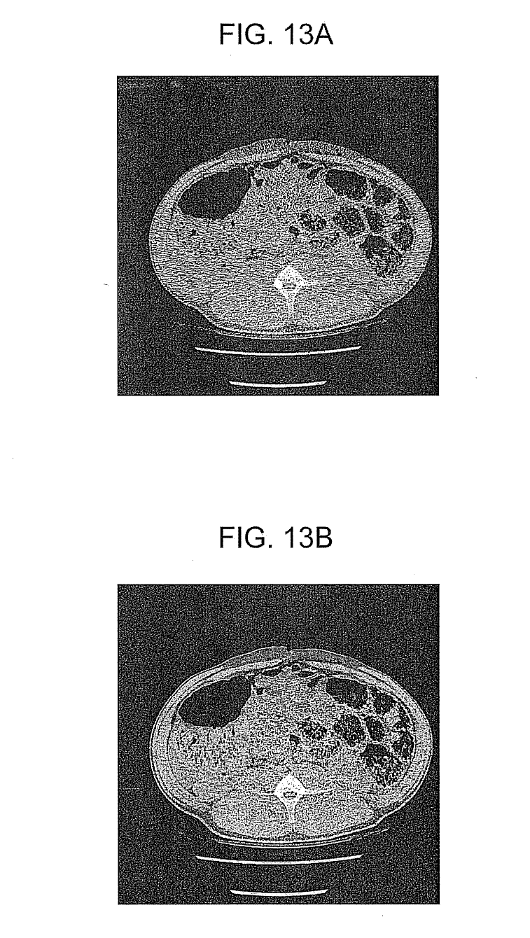

Now referring to FIG. 13A, an exemplary image illustrates a reconstructed image of the swine abdomen using a prior art filtered back projection technique. FIG. 13B is another exemplary image illustrating a reconstructed image of the swine abdomen using a technique with the optimized coefficients according to the current invention.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of generating images in a regularization-based iterative reconstruction technique, comprising:
determining a first coefficient based upon statistical information to be used in a predetermined data fidelity process on the image data to generate data fidelity update for a current iteration based upon the data fidelity process and the first coefficient;
determining a second coefficient based upon statistical information to be used in a predetermined regularization process on the image data to generate regularization update for the current iteration based upon the regularization process and the second coefficient; and
updating the image data according to a combination of the image data from a previous iteration, the data fidelity update and the regularization update to generate an updated image data.

2. The method of generating images in a regularization-based iterative reconstruction technique according to claim 1 wherein the data fidelity process is one of simultaneous algebraic reconstruction technique (SART) and algebraic reconstruction technique (ART).

3. The method of generating images in a regularization-based iterative reconstruction technique according to claim 1 wherein the regularization process is total variation (TV).

4. The method of generating images in a regularization-based iterative reconstruction technique according to claim 1 wherein the two determining steps are sequential.

5. The method of generating images in a regularization-based iterative reconstruction technique according to claim 1 wherein the two determining steps are concurrently performed.

6. The method of generating images in a regularization-based iterative reconstruction technique according to claim 1 wherein the first coefficient is determined based upon an amount of variance at a particular iteration by
$$α = \frac{Var \{ {x}^{( n - 1 )} \}}{Var \{ {x}^{( n - 1 )} \} + Var \{ {x}_{SART}^{( n )} \}}$$
where α is the first coefficient while an amount of the variance is Var{x⁽ⁿ⁾} at the particular iteration of n, Var{x⁽ⁿ⁻¹⁾} at the particular iteration of n−1 and Var{x_{SART}⁽ⁿ⁾} after the predetermined data fidelity process.

7. The method of generating images in a regularization-based iterative reconstruction technique according to claim 6 wherein the amount of the variance is defined by noise variance.

8. The method of generating images in a regularization-based iterative reconstruction technique according to claim 6 wherein the amount of the variance is defined by error variance.

9. The method of generating images in a regularization-based iterative reconstruction technique according to claim 1 wherein the second coefficient is determined based upon an amount of variance at a particular iteration
$$β = \frac{Var \{ {x}^{( n - 1 )} \}}{Var \{ {x}^{( n - 1 )} \} + Var \{ {x}_{REG}^{( n )} \}}$$
where β is the second coefficient while an amount of the variance is Var{x⁽ⁿ⁾} at the particular iteration of n, Var{x⁽ⁿ⁻¹⁾} at the particular iteration of n-1 and Var{x_{REG}⁽ⁿ⁾} after the predetermined regularization process.

10. The method of generating images in a regularization-based iterative reconstruction technique according to claim 9 wherein the amount of the variance is defined by noise variance.

11. The method of generating images in a regularization-based iterative reconstruction technique according to claim 9 wherein the amount of the variance is defined by error variance.

12. The method of generating images in a regularization-based iterative reconstruction technique according to claim 1 wherein the first coefficient and the second coefficient are determined based upon (α, β)=arg min ƒ(Δn, Δε), wherein α is the first coefficient, β is the second coefficient, ƒ(Δn, Δε) is a predetermined penalty function, Δn is a sum of noise in the data fidelity update and the regularization update, and Δε is a sum of error in matching the real data in the data fidelity update and the regularization update.

13. The method of generating images in a regularization-based iterative reconstruction technique according to claim 1 wherein said updating step updates the image data according to the sum of the image data from a previous iteration, the data fidelity update and the regularization update in a single step.

14. The method of generating images in a regularization-based iterative reconstruction technique according to claim 1 wherein the updated image data is iteratively used as the image data for a next iteration of the two determining steps and said updating step.

15. The method of generating images in a regularization-based iterative reconstruction technique according to claim 1 wherein said updating step includes a user-determined third coefficient for controlling a resolution-noise trade off

16. A system for generating images in a regularization-based iterative reconstruction technique, comprising:
a first coefficient unit for determining a first coefficient based upon statistical information to be used in a predetermined data fidelity process on the image data at to generate data fidelity update for a current iteration based upon the data fidelity process and the first coefficient;
a second coefficient unit for determining a second coefficient based upon statistical information to be used in a predetermined regularization process on the image data to generate regularization update for the current iteration based upon the regularization process and the second coefficient, wherein the first coefficient and the second coefficient are independent; and
an updating unit connected to said first coefficient unit and said second coefficient unit for updating the image data according to a sum of the image data from a previous iteration, the data fidelity update and the regularization update to generate an updated image data.

17. The system for generating images in a regularization-based iterative reconstruction technique according to claim 16 wherein said first coefficient unit performs the data fidelity process including one of simultaneous algebraic reconstruction technique (SART) and algebraic reconstruction technique (ART).

18. The system for generating images in a regularization-based iterative reconstruction technique according to claim 16 wherein said second coefficient unit performs the regularization process including total variation (TV).

19. The system for generating images in a regularization-based iterative reconstruction technique according to claim 16 wherein said first coefficient unit and said second coefficient unit sequentially perform.

20. The system for generating images in a regularization-based iterative reconstruction technique according to claim 16 wherein said first coefficient unit and said second coefficient unit concurrently perform.

21. The system for generating images in a regularization-based iterative reconstruction technique according to claim 16 wherein the first coefficient is determined based upon an amount of variance at a particular iteration by
$$α = \frac{Var \{ {x}^{( n - 1 )} \}}{Var \{ {x}^{( n - 1 )} \} + Var \{ {x}_{SART}^{( n )} \}}$$
where α is the first coefficient while an amount of the variance is Var{x⁽ⁿ⁾} at the particular iteration of n, Var{x⁽ⁿ⁻¹⁾} at the particular iteration of n-1 and Var{x_{SART}⁽ⁿ⁾} after the predetermined data fidelity process.

22. The system for generating images in a regularization-based iterative reconstruction technique according to claim 21 wherein the amount of the variance is defined by noise variance.

23. The system for generating images in a regularization-based iterative reconstruction technique according to claim 21 wherein the amount of the variance is defined by error variance.

24. The system for generating images in a regularization-based iterative reconstruction technique according to claim 16 wherein the second coefficient is determined based upon an amount of variance at a particular iteration
$$β = \frac{Var \{ {x}^{( n - 1 )} \}}{Var \{ {x}^{( n - 1 )} \} + Var \{ {x}_{REG}^{( n )} \}}$$
where β is the second coefficient while an amount of the variance is Var{x⁽ⁿ⁾} at the particular iteration of n, Var{x⁽ⁿ⁻¹⁾} at the particular iteration of n−1 and Var{x_{REG}⁽ⁿ⁾} after the predetermined regularization process.

25. The system for generating images in a regularization-based iterative reconstruction technique according to claim 24 wherein the amount of the variance is defined by noise variance.

26. The system for generating images in a regularization-based iterative reconstruction technique according to claim 43 wherein the amount of the variance is defined by error variance.

27. The system for generating images in a regularization-based iterative reconstruction technique according to claim 16 wherein the first coefficient and the second coefficient are determined based upon (α, β)=arg min ƒ(Δn, Δε), wherein α is the first coefficient, β is the second coefficient, ƒ(Δn, Δε) is a predetermined penalty function, Δn is a sum of noise in the data fidelity update and the regularization update, and Δε is a sum of error in matching the real data in the data fidelity update and the regularization update.

28. The system for generating images in a regularization-based iterative reconstruction technique according to claim 16 wherein said updating unit updates the image data according to the sum of the image data from a previous iteration, the data fidelity update and the regularization update in a single step.

29. The system for generating images in a regularization-based iterative reconstruction technique according to claim 16 wherein the updated image data is iteratively used as the image data for a next iteration in said first coefficient unit, said second coefficient unit and said updating unit.

30. The system for generating images in a regularization-based iterative reconstruction technique according to claim 16 wherein said updating unit includes a user-determined third coefficient for controlling a resolution-noise trade off.
